(19) United States
(12) Patent Application Publication
(10) Pub. No.: US 2025/0314989 A1
(43) Pub. Date: Oct. 9, 2025

(54) IMAGE FORMING APPARATUS

(71) Applicant: CANON KABUSHIKI KAISHA, Tokyo (JP)

(72) Inventors: HIROKI KATAYAMA, Shizuoka (JP); TAKU MUROTANI, Shizuoka (JP)

(21) Appl. No.: 19/080,843

(22) Filed: Mar. 15, 2025

(30) Foreign Application Priority Data
Apr. 8, 2024 (JP) 2024-062050
Feb. 25, 2025 (JP) 2025-027810

(51) Int. Cl. G03G 15/043; G02B 26/12; G03G 15/04; G03G 21/16

(52) U.S. Cl. CPC G03G 15/0435; G02B 26/12; G03G 15/04072; G03G 15/0409; G03G 21/1647; G03G 2215/0404; G03G 2221/1636

(57) ABSTRACT

A scanning optical device includes a polygon mirror to deflect and scan a luminous flux emitted from a light source, an imaging lens and an optical box. The imaging lens is long in a scanning direction of the polygon mirror. The optical box is provided with the polygon mirror and the imaging lens. The optical box includes two positioning portions to position one end and the other end of the imaging lens in the scanning direction. In a position adjacent to one positioning portion of the two positioning portions in the scanning direction and on a side of the other positioning portion, an inclined surface is provided. The inclined surface extends in a direction from the one positioning portion toward the other positioning portion and inclines so as to lower in height as it goes to the other positioning portion from the one positioning portion.

### FIELD OF THE INVENTION AND RELATED ART

The present invention relates to a scanning optical device used in an image forming apparatus such as a copy machine and a laser beam printer, an image forming apparatus equipped with this scanning optical device, and an assembly method for an imaging lens.

In Japanese Patent Application Laid-Open No. 2013-164536, a scanning optical device used in a color image forming apparatus using electrophotographic technology is disclosed. Specifically, a scanning optical device which irradiates photosensitive drums corresponding to four colors of yellow, magenta, cyan and black with a laser beam. In addition, cost reduction and downsizing of the image forming apparatus have been required in recent years. To this end, the scanning optical device disclosed in Japanese Patent Application Laid-Open No. 2013-164536 encapsulates a plurality of light sources and optical components corresponding to the four colors in a single optical box. Furthermore, the laser beams emitted from the plurality of the light sources are deflected by a single light deflector and each photosensitive drum is irradiated with the laser beam via a reflecting mirror. An fθ lens, which is one of the optical components used in the scanning optical device, is fixed in a state in which a position of the fθ lens with respect to the optical box is regulated by the fθ lens being in contact with a contact portion, which is provided in the optical box and has a projecting shape.

Upon assembling the plurality of the optical components in the single optical box, a shape of each optical component and positions and postures of the optical components with respect to the optical box are different. Therefore, in a case in which automatic assembly by a mechanical device is performed for a purpose of shortening of an assembly tact time, a configuration of the mechanical device to handle the optical boxes of different specifications becomes complicated and large-scale. Therefore, considering capital investment and labor cost, from a viewpoint of return on investment for the assembly, there is a case in which assembly steps of the optical components to the optical box are performed manually by a worker instead of by the mechanical device.

Upon the worker assembling the optical components, among the various optical components, the fθ lens in particular requires careful handling because the fθ lens has many portions which optically function. Specifically, upon the worker assembling the fθ lens to the optical box, in order to prevent a lens effective area of the fθ lens from being contaminated (for example, by fingerprints), the worker needs to grip an end portion instead of near a center of the fθ lens. In a case in which both end portions of the fθ lens are gripped, a position and a posture of the fθ lens during assembly becomes stable, but since the worker's hands are occupied, only one fθ lens can be assembled at a time.

On the other hand, for a purpose of improving productivity, in a case in which the worker grips only one end of the fθ lens and assembles the fθ lens to the optical box, while two fθ lenses can be assembled at the same time, but there are the following problems. That is, in the case in which only the one end of the fθ lens is gripped and an end portion of the fθ lens on a non-gripped side (hereinafter, referred to as a “non-gripped end”) is attempted to be in contact with the contact portion of the optical box, since the fθ lens is long, a position and a posture of the non-gripped end is not stable and it is difficult to make the non-gripped end be in contact therewith. Therefore, in order to assemble the fθ lens to the optical box in a state in which the position and the posture of the non-gripping end is stable, it is desirable of an assembly method in which the fθ lens is slid to the contact portion of the optical box in a state in which the non-gripped end is in contact with a flat portion such as a bottom surface of the optical box.

However, in a case in which the assembly method in which the non-gripped end is slid to the contact portion of the optical box in the state in which only one end of the fθ lens is gripped is implemented, there are the following problems. FIG. 11 is a cross-sectional view of a vicinity of the non-gripped end when this assembly method is implemented. An arrow Ds indicates a sliding direction of the fθ lens. As shown in FIG. 11, an fθ lens 300 is caught in a contact portion 320, which is provided to an optical box 310 and has a projecting shape to regulate a position of the fθ lens 300, an easiness in assembly of the fθ lens to the optical box is reduced. In addition, it also leads to a decrease in assembly accuracy due to scratches and dents to a surface for accuracy of each component caused by collision of the fθ lens, and to a decrease in quality due to assembly defect in which the fθ lens is not assembled in a normal position.

### SUMMARY OF THE INVENTION

The present invention is conceived under such a background, and an object of the present invention is to improve an easiness in assembly of an imaging lens to an optical box.

According to an aspect of the present invention, there is provided a scanning optical device comprising: a light source; a rotatable polygon mirror configured to deflect and scan a luminous flux emitted from the light source; an imaging lens long in a scanning direction of the rotatable polygon mirror and configured to image the luminous flux deflected and scanned by the rotatable polygon mirror onto a scanned surface; and an optical box in which the rotatable polygon mirror and the imaging lens are provided, wherein the optical box includes a positioning portion configured to position one end portion of the imaging lens in the scanning direction and a positioning portion configured to position the other end portion of the imaging lens in the scanning direction, and wherein in a position adjacent to the one positioning portion of the two positioning portions in the scanning direction and on a side of the other positioning portion, an inclined surface, extending in a direction from the one positioning portion toward the other positioning portion and inclined so as to lower in height as it goes to the other positioning portion from the one positioning portion, is provided.

According to another aspect of the present invention, there is provided a scanning optical device comprising: a light source; a rotatable polygon mirror configured to deflect and scan a luminous flux emitted from the light source; an imaging lens long in a scanning direction of the rotatable polygon mirror and configured to image the luminous flux deflected and scanned by the rotatable polygon mirror onto a scanned surface; and an optical box in which the rotatable polygon mirror and the imaging lens are provided, wherein the imaging lens includes a first positioned portion provided in a direction perpendicular to the scanning direction and in contact with the optical box in a first contact direction, a second positioned portion provided in a direction crossing the first positioned portion in an imaginary plane perpendicular to the scanning direction and in contact with the optical box in a second contact direction crossing the first contact direction, a third positioned portion in contact with the optical box in the scanning direction, and an inclined surface, the inclined surface being provided, when an angle formed between a rotational axis of the rotatable polygon mirror and the first contact direction is a first angle and an angle formed between the rotational axis and the second contact direction is a second angle, between a positioned portion with a smaller angle of the first angle and the second angle and the third positioned portion.

According to another aspect of the present invention, there is provided an assembly method for an imaging lens of a scanning optical device, wherein the scanning optical device includes a light source, a rotatable polygon mirror configured to deflect and scan a luminous flux emitted from the light source, an imaging lens long in a scanning direction of the rotatable polygon mirror and configured to image the luminous flux deflected and scanned by the rotatable polygon mirror onto a scanned surface, and an optical box including a bottom surface on which the rotatable polygon mirror and the imaging lens are provided, wherein the optical box in one end portion thereof in the scanning direction, includes a first positioning portion protruding from a periphery and configured to position the imaging lens in a first contact direction perpendicular to the scanning direction, a second positioning portion configured to position the imaging lens in a second contact direction perpendicular to the scanning direction and crossing the first contact direction, a third positioning portion configured to position the imaging lens in the scanning direction, and an inclined surface extending so as to lower in height as it goes to the other end portion in the scanning direction from the first positioning portion, and wherein the imaging lens includes a first positioned portion in contact with the first positioning portion, a second positioned portion in contact with the second positioning portion, a third positioned portion in contact with the third positioning portion, a first corner portion between the first positioned portion and the third positioned portion, and a second corner portion between the first positioned portion and the third positioned portion and opposite to the first corner portion, and the assembling method comprising: a step for moving up the first corner portion along the inclined surface by bringing the first corner portion into contact with the bottom surface and sliding the imaging lens toward the first positioning portion; a step for contacting the second corner portion to the third positioning portion and for bringing the third positioned portion into contact with the third positioning portion while moving the other end portion of the imaging lens in the scanning direction toward the bottom surface; a step for temporarily placing the imaging lens on the bottom surface by bringing the first positioned portion into contact with the first positioning portion; and a step for bringing the second positioned portion into contact with the second positioning portion.

According to another aspect of the present invention, there is provided an assembly method for an imaging lens of a scanning optical device, wherein the scanning optical device includes a light source, a rotatable polygon mirror configured to deflect and scan a luminous flux emitted from the light source, an imaging lens long in a scanning direction of the rotatable polygon mirror and configured to image the luminous flux deflected and scanned by the rotatable polygon mirror onto a scanned surface, and an optical box including a bottom surface on which the rotatable polygon mirror and the imaging lens are provided, wherein the imaging lens includes a first positioned portion provided in a direction perpendicular to the scanning direction and in contact with the optical box in a first contact direction, a second positioned portion provided in a direction crossing the first positioned portion in a imaginary plane perpendicular to the scanning direction and in contact with the optical box in a second contact direction crossing the first contact direction, a third positioned portion in contact with the optical box in the scanning direction, and an inclined surface, the inclined surface being provided, when an angle formed between a rotational axis of the rotatable polygon mirror and the first contact direction is a first angle and an angle formed between the rotational axis and the second contact direction is a second angle, between a positioned portion with a smaller angle of the first angle and the second angle and the third positioned portion. and the assembling method comprising: a step for moving the first positioning portion and the inclined surface in a state in contact with each other by bringing on an end portion of the imaging lens into contact with the bottom surface and sliding toward the first positioning portion; a step for contacting a corner portion opposite to a corner portion between the inclined surface in contact with the bottom surface and the third positioned portion to the third positioning portion and for bringing the third positioned portion into contact with the third positioning portion while moving the other end portion of the imaging lens in the scanning direction toward the bottom surface; a step for temporarily placing the imaging lens on the bottom surface by bringing the first positioned portion into contact with the first positioning portion; and a step for bringing the second positioned portion into contact with the second positioning portion.

Further features of the present invention will become apparent from the following description of exemplary embodiments with reference to the attached drawings.

### BRIEF DESCRIPTION OF THE DRAWINGS

FIG. 1 is a cross-sectional view of an image forming apparatus.

FIG. 2 is a perspective view of a scanning optical device in an Embodiment 1.

FIG. 3 is a sectional view of the scanning optical device in 1 the Embodiment 1.

FIG. 4 is a perspective view of a second imaging lens in the Embodiment 1.

FIG. 5A is a perspective view of a part of an optical box in the Embodiment 1.

FIG. 5B is a perspective view of a part of the optical box in the Embodiment 1.

FIG. 5C is a perspective view of a part of the optical box in the Embodiment 1.

FIG. 6 is a cross-sectional view around a contact portion of the optical box in the Embodiment 1.

FIG. 7A is an explanatory view illustrating an assembly step of the second imaging lens to the optical box in the Embodiment 1.

FIG. 7B is an explanatory view illustrating the assembly step of the second imaging lens to the optical box in the Embodiment 1.

FIG. 7C is an explanatory view illustrating the assembly step of the second imaging lens to the optical box in the Embodiment 1.

FIG. 7D is an explanatory view illustrating the assembly step of the second imaging lens to the optical box in the Embodiment 1.

FIG. 7E is an explanatory view illustrating the assembly step of the second imaging lens to the optical box in the Embodiment 1.

FIG. 8 is an explanatory view showing that assembly efficiency of the second imaging lens in the Embodiment 1 is improved.

FIG. 9 is a perspective view of a second imaging lens in an Embodiment 2.

FIG. 10 is an explanatory view showing that assembly efficiency of the second imaging lens in the Embodiment 2 is improved.

FIG. 11 is a view illustrating an example of an assembly step of an fθ lens to an optical box.

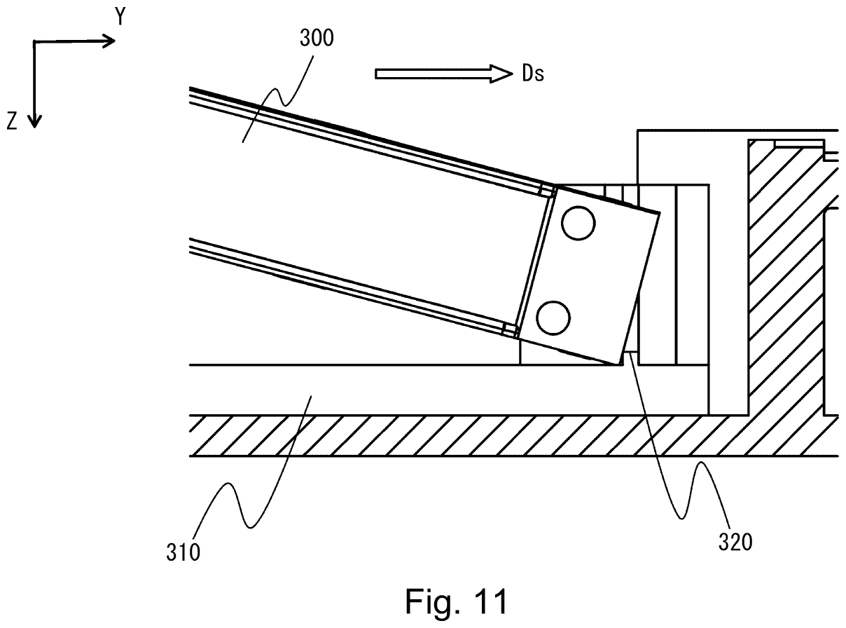

FIG. 12 is a cross-sectional view illustrating a Modified Example 1 of the Embodiment 1.

FIG. 13 is a cross-sectional view illustrating a Modified Example 2 of the Embodiment 1.

FIG. 14 is a perspective view illustrating the Modified Example 2 of the Embodiment 1.

### DESCRIPTION OF THE EMBODIMENTS

### Embodiment 1

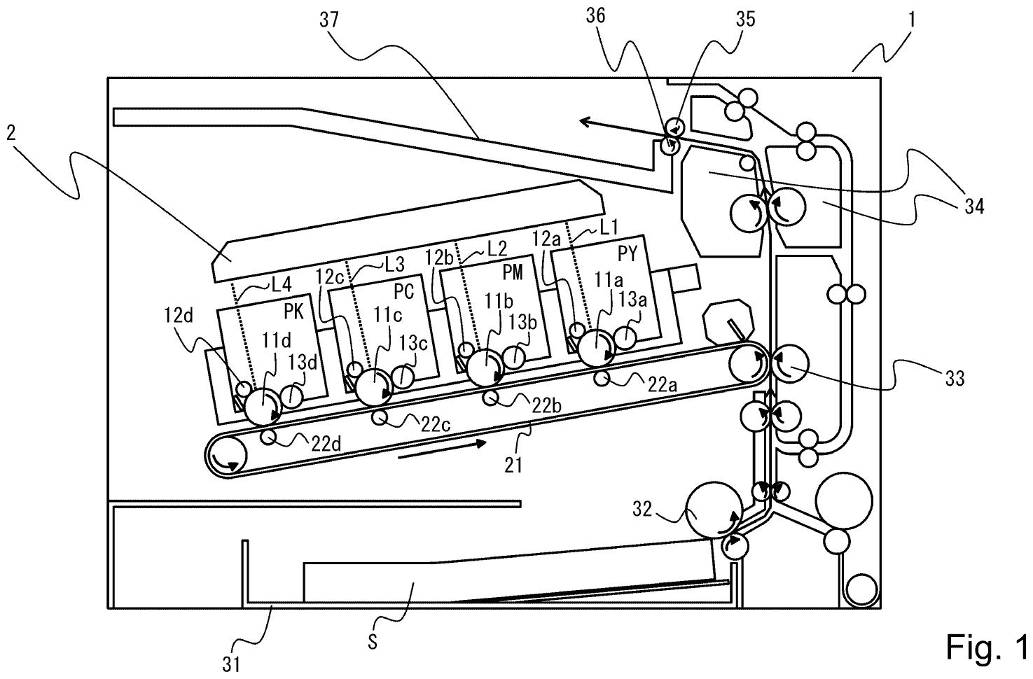

With reference to FIG. 1 through FIG. 10, an Embodiment 1 of an image forming apparatus 1 of the present invention will be described.

### Outline of an Image Forming Apparatus

FIG. 1 is a cross-sectional outline view of the image forming apparatus 1 in the Embodiment 1. The image forming apparatus 1 in the Embodiment 1 is a color image forming apparatus which forms a full-color image by superimposing four colors of yellow, cyan, magenta and black. Next, an image forming process will be described. To process cartridges PY, PM, PC and PK which corresponds to each color, photosensitive drums 11a, 11b, 11c and 11d as image bearing members (scanned surfaces), charging rollers 12a, 12b, 12c and 12d which are chargers, and developing rollers 13a, 13b, 13c and 13d which are developers are provided. Incidentally, the process cartridges PY, PM, PC and PK may be collectively referred to as a process cartridge P. In addition, for members provided to each process cartridge P, a represents yellow, b represents magenta, c represents cyan, and d represents black, and hereinafter, a through d of the members in the process cartridge P are also omitted except when a member of a particular color is described. The same applies to a primary transfer roller 22 described below.

The photosensitive drums 11, which are charged in advance by the charging rollers 12, are irradiated by laser luminous fluxes L1, L2, L3 and L4 emitted from a scanning optical device 2, which is an exposure device, so that electrostatic latent images are formed on surfaces thereof, respectively. The electrostatic latent image is turned into a toner image by a developing roller 13 as a developing means, and the toner image on the photosensitive drum 11 is transferred to an intermediary transfer belt 21 by the primary transfer roller 22 (primary transfer). Meanwhile, a recording paper S as a recording material placed in a paper cassette 31, which is disposed downside the intermediary transfer belt 21, is taken out by a pickup roller 32 timed with the image forming process. Thereafter, on the conveyed recoding paper S, the toner images of the four colors on the intermediary transfer belt 21 are transferred by a secondary transfer roller 33 as a transfer means (secondary transfer). By the recording paper S finally passing through a fixing device 34, the unfixed toner images are fixed, and the recording paper S is discharged by discharging rollers 35 and 36 to a discharge tray 37 outside the image forming apparatus 1.

### Outline of the Scanning Optical Device

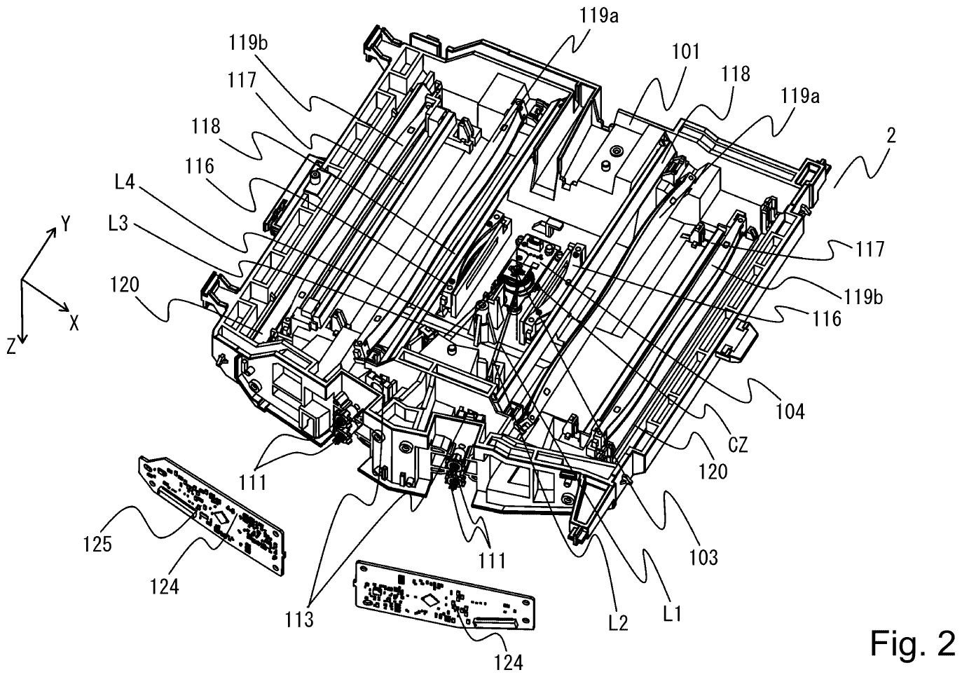

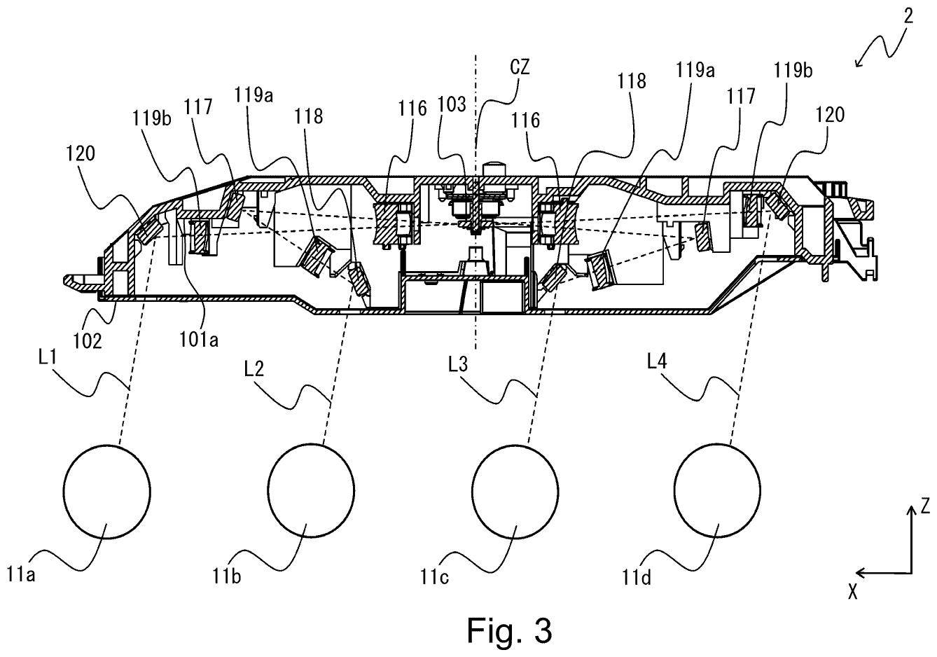

Next, using FIG. 2 and FIG. 3, the scanning optical device 2 in the Embodiment 1 will be described. FIG. 2 is a perspective outline view illustrating a configuration of the scanning optical device 2, and shows a state in which a lid 102 (see FIG. 3) is removed to describe an inside of the scanning optical device 2. In a coordinate system in the Embodiment 1, a rotational axis CZ direction of a rotatable polygon mirror 103 is defined as a Z direction, a direction in which the laser luminous fluxes L1, L2, L3 and L4 deflected by the rotatable polygon mirror 103 scan is defined as a Y direction, and a direction perpendicular to the Y direction and the Z direction is defined as an X direction.

To side surfaces of an optical box 101 in the scanning optical device 2, four semiconductor lasers 111 as light sources are attached. The laser luminous fluxes L1, L2, L3 and L4 emitted from the four semiconductor lasers 111 are made, by an anamorphic lens 113, in which a collimator lens and a cylindrical lens are integrally formed, into approximately collimated light or converged light in the X direction and converged light in the Z direction. Thereafter, the laser luminous fluxes L1, L2, L3 and L4 are then limited in luminous flux width by a sub scanning aperture diaphragm and a main scanning aperture diaphragm, which are not shown, and form an image in a line shape having a certain width in the X direction on a deflecting and reflecting surface of the rotatable polygon mirror 103.

A scanner motor 104, which rotationally drives the rotatable polygon mirror 103 about the rotational axis CZ, is attached to the optical box 101 by an unshown screw. A beam detector (hereinafter, referred to as a BD) 125 is mounted on a control board 124. In the Embodiment 1, the laser luminous flux L4 is reflected by the rotatable polygon mirror 103, deflected and scanned, and incident on the BD 125. At this time, a signal output from the BD 125 (hereinafter, referred to as a BD signal) is used as a reference to perform writing out control of the images of each color.

Next, using FIG. 3 as well, scanning optical systems of the laser luminous fluxes L1, L2, L3 and L4 after reflected by the rotatable polygon mirror 103 in the Embodiment 1 will be described. FIG. 3 is a sub scanning cross-sectional view of the scanning optical system illustrating optical passages of the laser luminous fluxes L1, L2, L3 and L4, which are deflected and scanned by the rotatable polygon mirror 103, until reaching the photosensitive drums 11a, 11b, 11c and 11d. Incidentally, the Embodiment 1 is an optical system referred to as an oblique incidence scanning optical system, and it is an optical system in which the laser luminous fluxes L1, L2, L3 and L4 are obliquely incident on the deflecting and reflecting surface of the rotatable polygon mirror 103 in the Z direction and separated into upper and lower optical passages after being reflected by the rotatable polygon mirror 103. Since it is the oblique incidence scanning optical system, in the Z direction, the laser luminous fluxes L1 and L3 are reflected to a downside and the laser luminous fluxes L2 and L4 are reflected upside by the rotatable polygon mirror 103. Thereafter, the laser luminous fluxes L1, L2, L3 and L4 are incident on a first imaging lens 116.

Next, the laser luminous fluxes L2 and L3 are reflected by a first reflecting mirror 117. Thereafter, after passing through a second imaging lens 119a, the laser luminous fluxes L2 and L3 are reflected again by a second reflecting mirror 118 and reach the photosensitive drums 11b and 11c. In addition, after passing through a second imaging lens 119b, the laser luminous fluxes L1 and L4 are reflected by a third reflecting mirror 120 and reach the photosensitive drums 11a and 11d. With the such configuration, the first imaging lens 116 is disposed as a common lens for the laser luminous fluxes L1, L2, L3 and L4, the second imaging lens 119a is disposed as a common lens for the laser luminous fluxes L2 and L3, and the second imaging lens 119b is disposed as a common lens for the laser luminous fluxes L1 and L4, respectively. Each imaging lens is fixed to the optical box 101 by a UV adhesive and each reflecting mirror is fixed thereto by an unshown urging member. In addition, a lid 102 for preventing dust or fuzz from entering the scanning optical device 2 is attached to the optical box 101 by an unshown screw.

Hereinafter, shapes of the optical box 101 around a plurality of contact portions (positioning portions) which regulate (positions) the second imaging lenses 119a and 119b and positions of the second imaging lenses 119a and 119b will be described. Incidentally, shapes of the second imaging lens 119a and the second imaging lens 119b and the shapes of the optical box 101 around the contact portions for each lens are of similar configurations. Therefore, in the Embodiment 1, the second imaging lens 119b, through which the laser luminous flux L1 passes, and the corresponding contact portions of the optical box 101 and peripheral configurations thereof will be described representatively.

### Outer Shape of the Second Imaging Lens

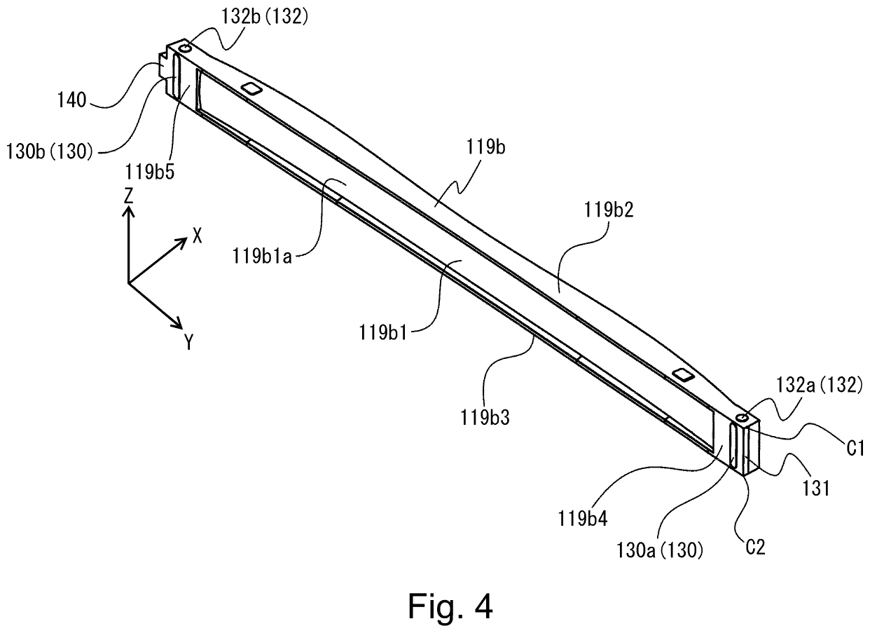

Next, using FIG. 4, the shape of the second imaging lens 119b in the Embodiment 1 will be described. To the second imaging lens 119b, two positioned portions 130 and 132 are provided at both ends in the Y direction (in other words, in a longitudinal direction), respectively. In addition, the same shape as the positioned portion 132 is also provided on a surface of an opposite side (surface on a −Z direction side in FIG. 4). With these configurations, by flipping upside down, as described above, the second imaging lens 119b can be used as a common lens for the laser luminous flux L1 and the laser luminous flux L4.

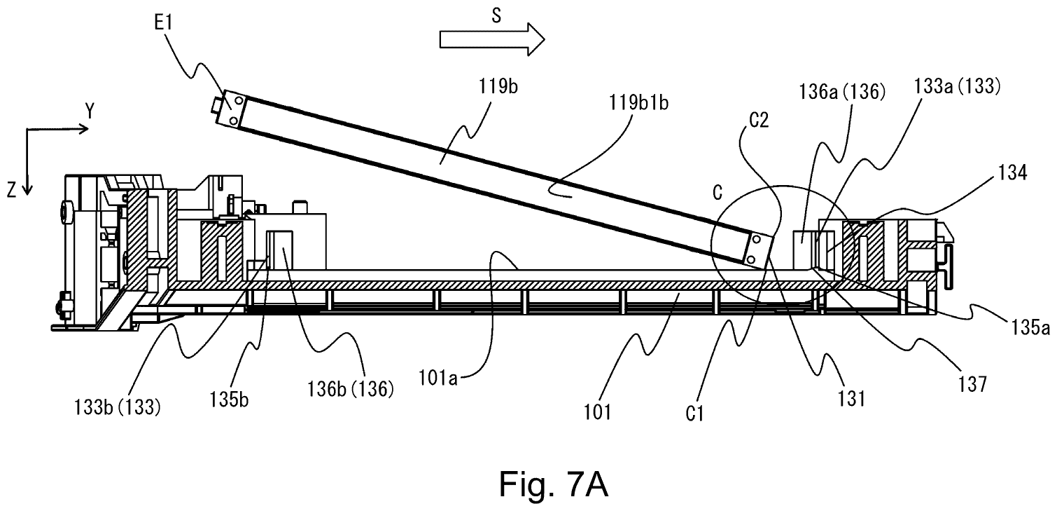

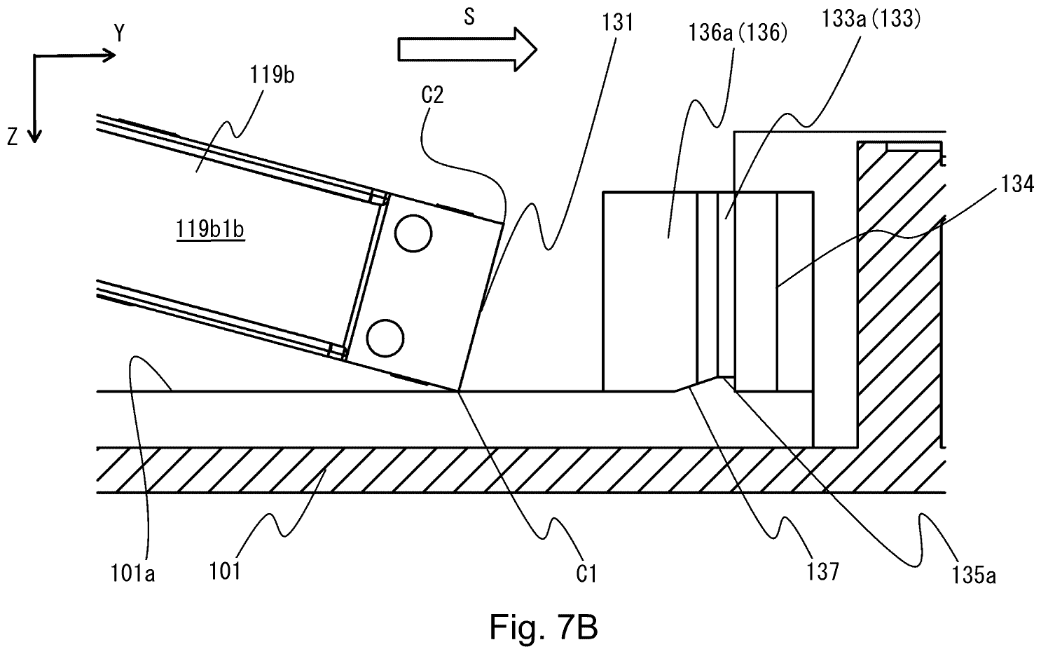

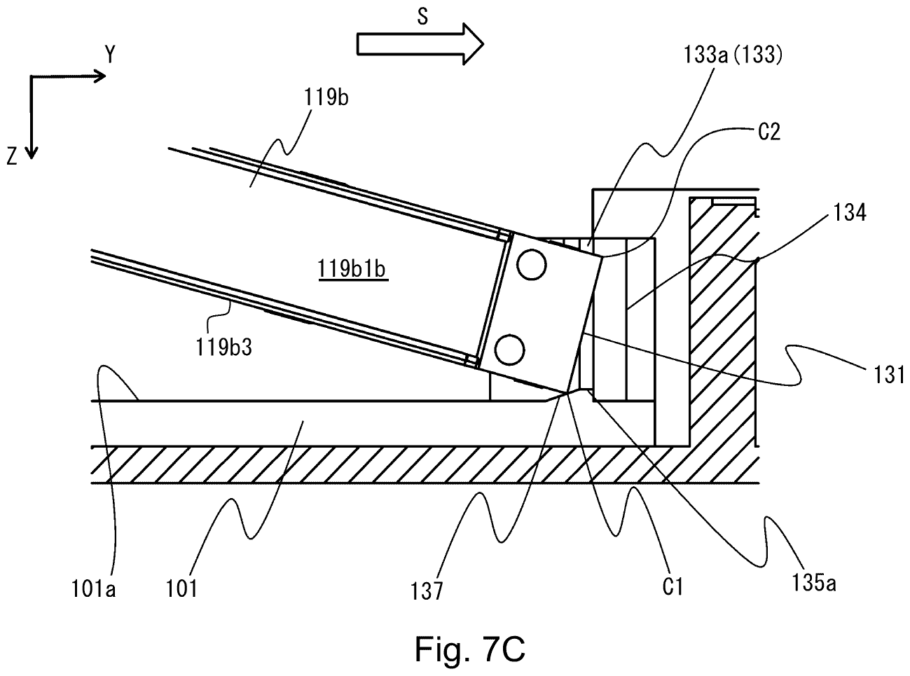

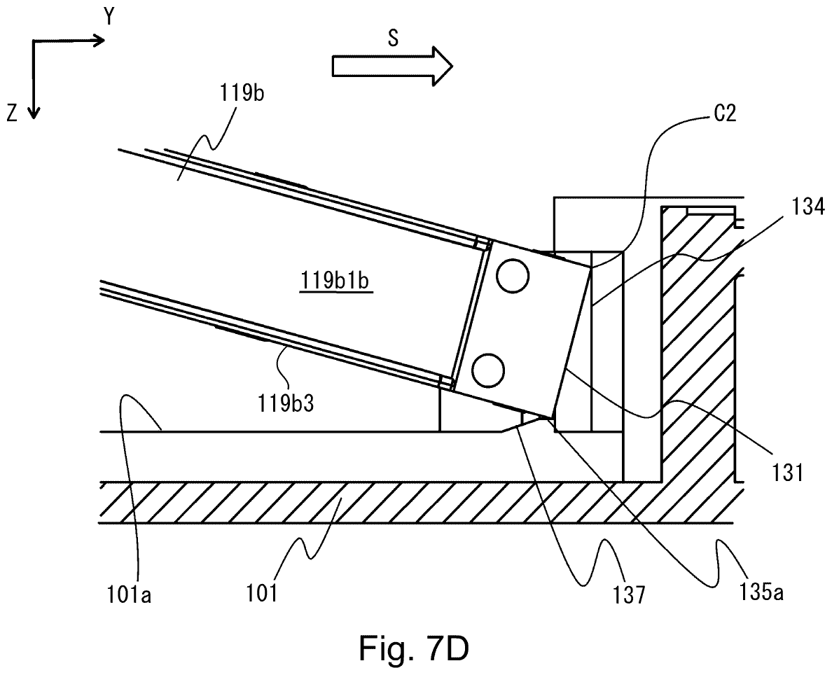

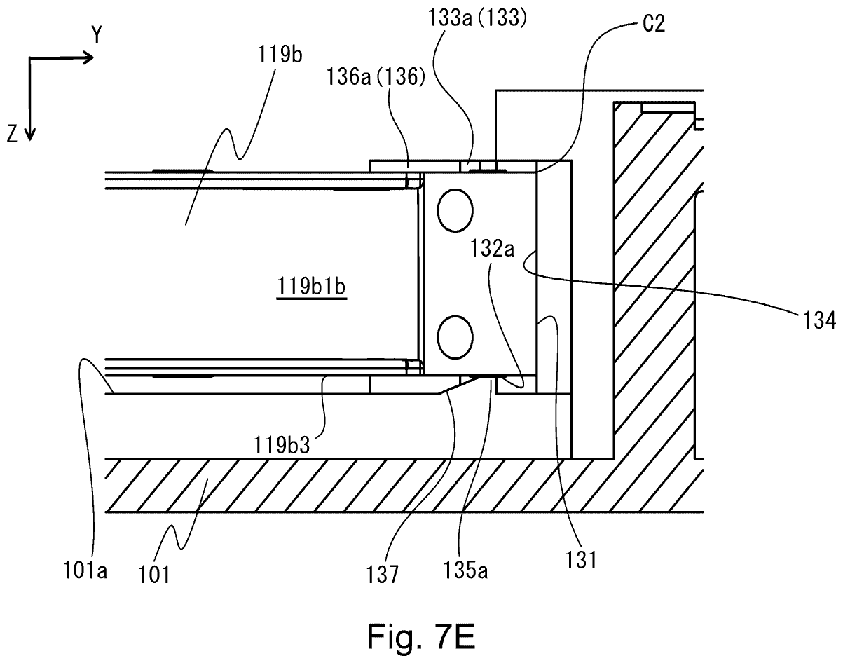

In more detail, the second imaging lens 119b includes a lens portion 119b1, surfaces 119b2 and 119b3, and end portion surfaces 119b4 and 119b5. The lens portion 119b1 is a portion through which the laser luminous flux L1 or the laser luminous flux L4 passes as described above. The lens portion 119b1 includes a surface 119b1a, on which the laser luminous flux L1 or the laser luminous flux L4 is incident, and a surface 119b1b (see FIG. 7A), from which the laser luminous flux L1 or the laser luminous flux L4 is emitted.

The surface 119b2 is a surface perpendicular to the surface 119b1a of the lens portion 119b1 and is a surface provided along the longitudinal direction of the second imaging lens 119b. With respect to the longitudinal direction of the second imaging lens 119b, at both end portions of the surface 119b2, the positioned portions 132 (132a and 132b) described above are provided. Specifically, the positioned portion 132a is provided at one end portion in the longitudinal direction of the second imaging lens 119b, and the positioned portion 132b is provided at the other end portion. The surface 119b3 is a surface on an opposite side of the surface 119b2, and at positions of the surface 119b3 corresponding to the positioned portions 132 (132a and 132b) provided on the surface 119b2, positioned portions (not shown) are provided, respectively. Incidentally, in FIG. 4, the positioned portion 132 has a circular shape, however, the positioned portion 132 may have another shape such as an elliptical shape, for example. The end portion surface 119b4 is a surface perpendicular to the surface 119b2 and the surface 119b3 and is provided on one end portion side of the lens portion 119b1, and a positioned portion 130a (130) is provided thereto. The end portion surface 119b5 is a surface perpendicular to the surface 119b2 and the surface 119b3 and is provided on the other end portion side of the lens portion 119b1, and a positioned portion 130b (130) is provided thereto. The positioned portion 130 has, in FIG. 4, a long elliptical shape extending in a direction perpendicular to the surfaces 119b2 and 119b3, i.e., in the Z direction. Incidentally, the shape of the positioned portion 130 is not limited to the elliptical shape, but may be another shape such as a rectangular shape, for example. In addition, the positioned portion 130 may have a configuration in which a plurality of circular shapes are arranged in the Z direction, etc.

At one end (one end portion) of the second imaging lens 119b, a positioned portion 131 is provided. A corner portion C1 as a first corner portion is formed by the surface 119b2 and the positioned portion 131. A corner portion C2 as a second corner portion is formed by the surface 119b3 and the positioned portion 131. In addition, at the other end (other end portion) of the second imaging lens 119b, a projecting portion 140 is provided. The projecting portion 140 projects, in the longitudinal direction, from the end portion surface 11965 toward a direction away from the lens portion 119b1.

### Shape of the Optical Box Around the Contact Portions Regulating the Position of the Second Imaging Lens

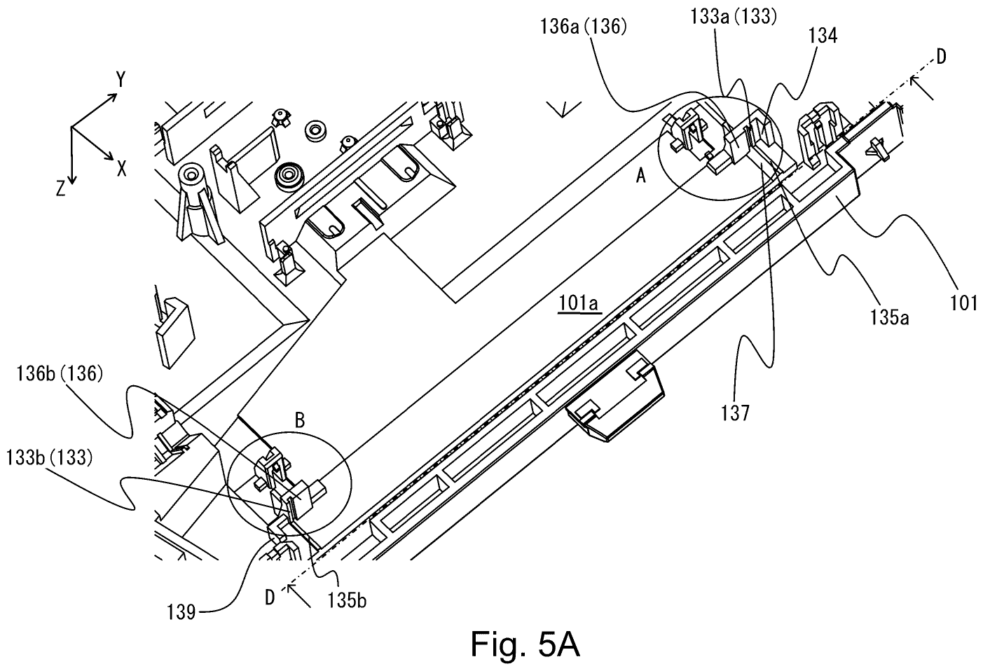

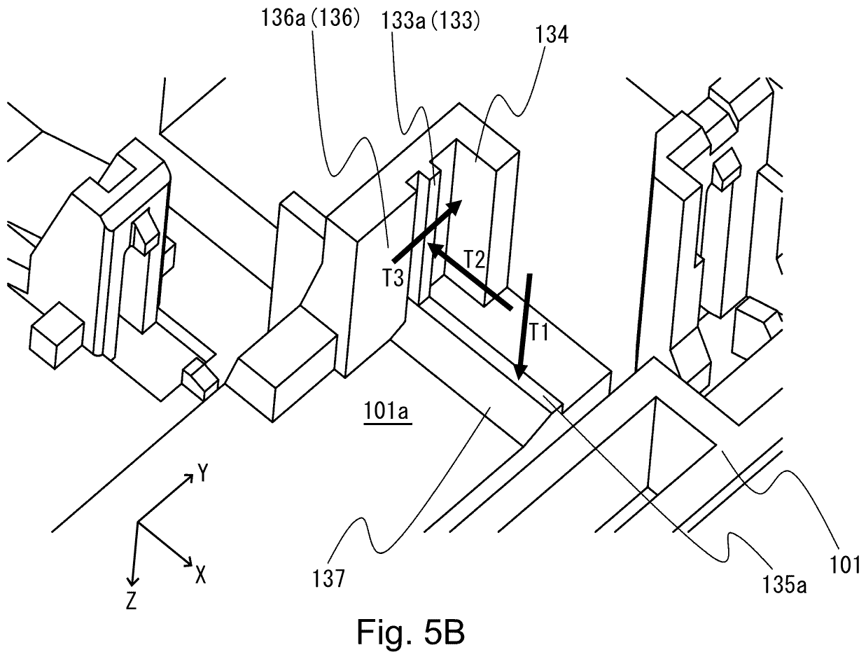

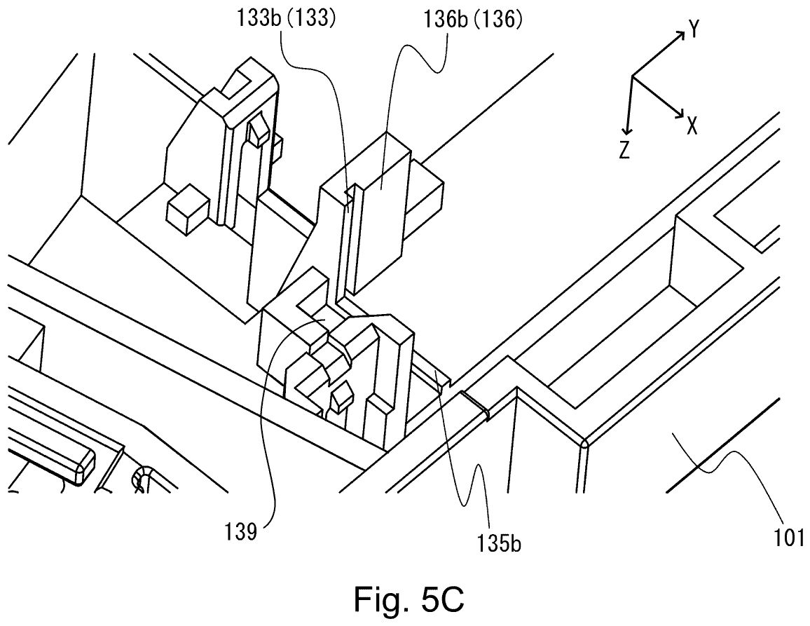

Next, using FIG. 5, “the second imaging lens 119b which is disposed on a laser beam passage of the laser luminous flux L1”, the contact portions with which the second imaging lens 119b is in contact, the periphery thereof, and the shape of the optical box 101 will be described. FIG. 5A is a perspective view of the contact portions and the periphery thereof of the optical box 101. FIG. 5B is a detailed view of a vicinity of a circularly framed portion A in FIG. 5A. FIG. 5C is a detailed view of a vicinity of a circularly framed portion B in FIG. 5A. Incidentally, the circularly framed portion A is an area corresponding to the one end portion of the second imaging lens 119b, and the circularly framed portion B is an area corresponding to the other end portion of the second imaging lens 119b.

To the optical box 101, the contact portions with which the second imaging lens 119b is in contact are provided, and the contact portions are provided, in a scanning direction, at a position corresponding to the one end portion of the second imaging lens 119b and at a position corresponding to the other end portion of the second imaging lens 119b, respectively. Specifically, to the optical box 101, contact portions (positioning portions which position the second imaging lens 119b) 133, 134, 135a and 135b, with which the second imaging lens 119b is in contact with, and an adhesion portion 136 for fixing the second imaging lens 119b are provided. The contact portions 133, 135a and 135b are projecting, to facilitate dimensional accuracy upon molding, from peripheries of each contact portion, and in more detail, have projecting shapes relative to the peripheries thereof, respectively. Incidentally, upon the second imaging lens 119b being assembled to the optical box 101, the contact portion 133a as a second contact portion is in contact with the positioned portion 130a as a second positioned portion, and the contact portion 133b is in contact with the positioned portion 130b (see also FIG. 4). In addition, the contact portion 135a as a first contact portion is in contact with the positioned portion 132a as a first positioned portion, the contact portion 135b is in contact with the positioned portion 132b, and the contact portion 134 as a third contact portion is in contact with the positioned portion 131 as a third positioned portion (see also FIG. 4). In this manner, to the vicinity of the circularly framed portion A in FIG. 5A, the one end portion of the second imaging lens 119b of FIG. 4 is assembled, and to the vicinity of the circularly framed portion B, the other end portion of the second imaging lens 119b of FIG. 4 is assembled. Incidentally, the contact portions 135a and 133a correspond to one contact portions, and the contact portions 135b and 133b correspond to the other contact portions. With these configurations, the second imaging lens 119b is positioned in the X, Y and Z directions with respect to the optical box 101.

Incidentally, the contact portion 133 is the second positioning portion which determines a position of the second imaging lens 119b in the X axis direction. The contact portion 134 is the third positioning portion which determines a position of the second imaging lens 119b in the Y axis direction. The contact portion 135a is the first positioning portion which determines a position of the second imaging lens 119b in the Z axis direction. The contact portion 135b is the other first positioning portion which determines the position of the second imaging lens 119b in the Z axis direction. Surfaces of these contact portions (positioning portions), with which the second imaging lens 119b is in contact, are flat surfaces (positioning surfaces).

In addition, between the contact portion 135a on the one end portion side and a bottom surface 101a of the optical box 101, a slope 137 as an inclined surface, which is inclined toward the other contact portion 135b, is provided. In other words, a height of the slope 137 from the bottom surface 101a of the optical box 101 is gradually lowered from a height of the contact portion 135a toward the contact portion 135b of the other end portion. It is desirable that a ridge line connecting the contact portion 135a and the slope 137 have, for example, a smooth shape which is a blend shape (curved surface shape). Incidentally, the contact portions 135a and 133a can be said as contact portions provided on the end portion side to which the inclined surface is provided, while the contact portions 135b and 133b can be said as contact portions provided on the end portion side to which the inclined surface is not provided.

In the Embodiment 1, the contact portion 135a has a rectangular projecting shape, however, it is not limited thereto but, for example, it may have a cylindrical projecting shape. In a case of the cylindrical projecting shape, the inclined surface may be a surface extending radially from the contact portion 135a. Incidentally, upon assembling optical components to the optical box 101, it is common that the bottom surface 101a of the optical box 101 is faced downside and the Z direction is a gravity direction. Incidentally, the bottom surface 101a in the scanning optical device 2 in the present Embodiment is, as shown in FIG. 3, a surface facing the +Z direction. In addition, the bottom surface 101a is, as viewed in the Z direction, a surface which is overlapped with most of an area of the lens portion 119b1 of the second imaging lens 119b in the longitudinal direction.

### About the Slope

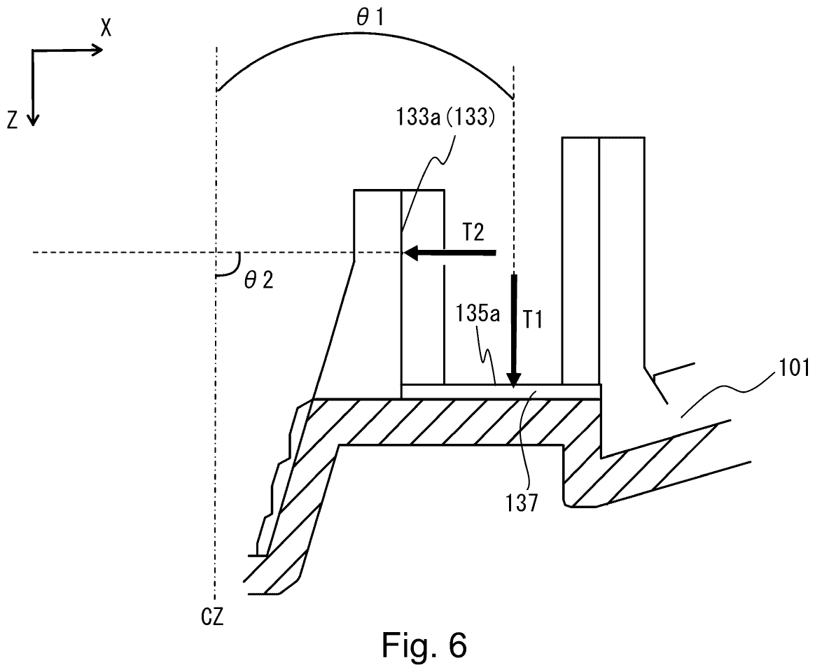

Next, using FIG. 6, an area adjacent to the contact portion, to which the slope 137 is provided, will be described. FIG. 6 is a partial cross-sectional view in the vicinity of the contact portion 135a of the second imaging lens 119b (view seen in the Y direction), and shows a cross-sectional view in an imaginary plane perpendicular to the scanning direction. In the description below, a direction in which the second imaging lens 119b is in contact with the contact portion 135a is referred to as a contact direction T1 as a first contact direction, and a direction in which the second imaging lens 119b is in contact with the contact portion 133a is referred to as a contact direction T2 as a second contact direction. The second contact direction is a direction crossing the first contact direction. Incidentally, a third contacting direction T3 (see FIG. 5B), which is a direction in which the second imaging lens 119b is in contact with the contact portion 134, is a direction perpendicular to the contact direction T1 and the contact direction T2, and is parallel to the scanning direction (in more detail, the +Y direction).

In the Embodiment 1, an angle between the rotational axis CZ of the rotatable polygon mirror 103 and the contact direction T2 of the second imaging lens 119b at the contact portion 133a is defined as θ2 as a second angle. In addition, an angle between the rotational axis CZ and the contact direction T1 of the second imaging lens 119b at the contact portion 135a is defined as θ1 as a first angle. Incidentally, in the Embodiment 1, θ2 is 90° and θ1 is 0°. In this case, the contact direction T2 is a direction perpendicular to the contact direction T1. The slope 137 is provided adjacent to the contact portion with a smaller angle with the rotational axis CZ of the rotatable polygon mirror 103. In the Embodiment 1, the slope 137 is provided at the contact portion 135a because of relationship of θ1<θ2. In addition, since the relationship is θ1<θ2, the contact direction T1 has an inclination closer to the gravity direction than the contact direction T2. In addition, the slope 137 is disposed, in the longitudinal direction of the lens, on a farther side from the contact portion 134 than the contact portion 135a.

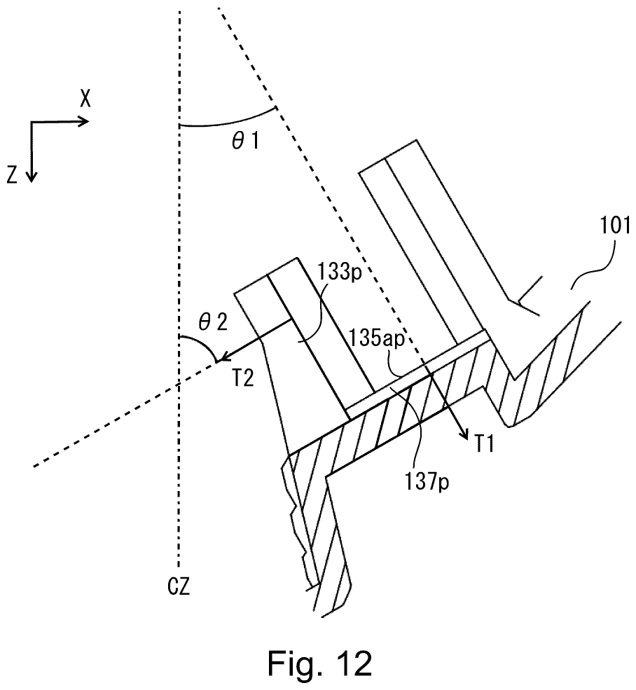

FIG. 12 through FIG. 14 show Modified Examples of the Embodiment 1 in which the relationship of θ1 and θ2 are different from that in FIG. 6. FIG. 12 is a Modified Example 1 and, relative to the Embodiment 1 (FIG. 6), has a configuration in which contact surfaces 133p and 135ap are inclined by 30° about the Y axis. In FIG. 12, θ1 is 30° and θ2 is 60°. Therefore, as in FIG. 6, the relationship is θ1<θ2, then a slope 137p is provided adjacent to a contact portion 135ap. In addition, since the relationship is θ1<θ2, as in FIG. 6, the contact direction T1 has an inclination closer to the gravity direction than the contact direction T2.

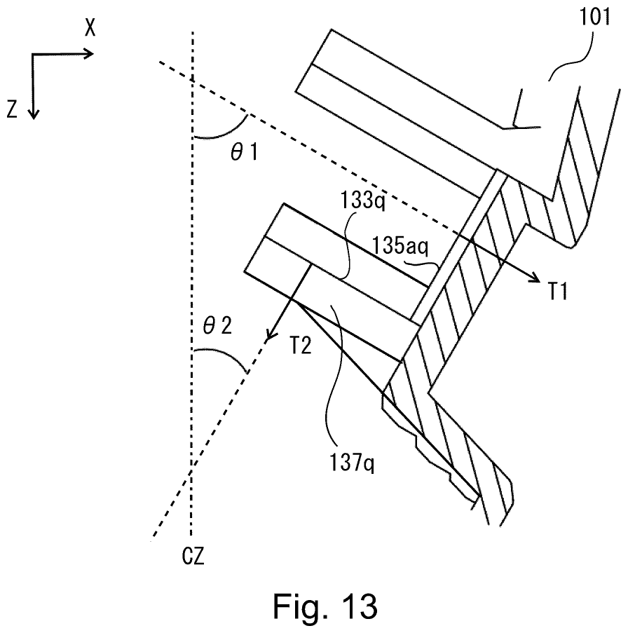

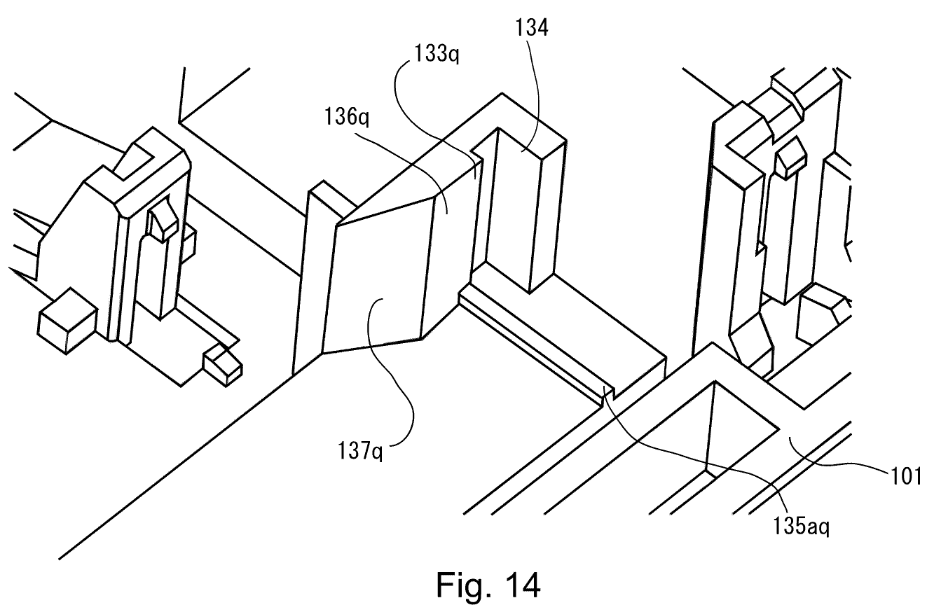

FIG. 13 is a Modified Example 2 and, relative to the Embodiment 1 (FIG. 6), has a configuration in which contact surfaces 133q and 133aq are inclined by 60° about the Y axis. In FIG. 13, θ1 is 60° and θ2 is 30°. Therefore, since θ1>θ2, a slope 137q is provided adjacent to the contact portion 133q (more precisely, adjacent to an adhesion portion 136q) rather than adjacent to the contact portion 135aq. FIG. 14 is a perspective view of the Modified Example 2. In addition, since the relationship is θ1>θ2, the contact direction T2 has an inclination closer to the gravity direction than the contact direction T1. Incidentally, in FIG. 14, the contact portion 133q and the adhesion portion 136q are in one plane. By this, upon assembling to the device, it becomes possible to move the second imaging lens 119b, which is moved in a state in which of being in contact with the slope 137q, smoothly to the contact portion 133q via the adhesion portion 136q. In the Modified Example 2, no slope is provided adjacent to the contact portion 135aq.

As described above, depending on the magnitude relationship between θ1 and θ2, the position to which the slope 137 is provided is adjusted. Incidentally, in the present Embodiment, the rotational axis CZ direction and the gravity direction is parallel.

### Assembly Method for the Second Imaging Lens

Next, assembly steps for the second imaging lens 119b to the optical box 101 in the Embodiment 1 will be described using FIG. 7A through FIG. 7E. FIG. 7A is an outline view at a start of the assembly steps, and FIG. 7B is a detailed view of a circularly framed portion C shown in FIG. 7A at the start of the assembly steps. FIG. 7C through FIG. 7E show detailed views at each timing of the assembly steps. FIG. 7A etc. are cross-sectional views at a D-D line shown in FIG. 5A.

In the Embodiment 1, upon assembling the second imaging lens 119b to the optical box 101, in a state of gripping an end portion E1 of the second imaging lens 119b (FIG. 7A), the worker brings the corner portion C1 on the positioned portion 131 side into contact with the bottom surface 101a of the optical box 101 (FIG. 7B). Incidentally, the end portion E1 is the other end portion of the second imaging lens 119b described in FIG. 4, the end portion to which the projecting portion 140 is provided, and the end portion on an opposite side in the Y axis direction to the side to which the corner portion C1 is provided.

Thereafter, from the state in which the second imaging lens 119b is in contact with the bottom surface 101a of the optical box 101, the worker slides the second imaging lens 119b in an S direction indicated by an arrow in FIG. 7A. Then the second imaging lens 119b climbs the slope 137 provided in front of the contact portion 135a in the S direction (FIG. 7C). And the worker brings the positioned portion 131 into contact with the contact portion 134 by continuing to move the second imaging lens 119b in the S direction (FIG. 7D). In more detail, the corner portion C1 of the second imaging lens 119b is moved from the bottom surface 101a of the optical box 101 to the slope 137, climbs the slope 137, and the corner portion C2 is in contact with the contact portion 134. By this, regulation (positioning) of movement in the Y direction (longitudinal direction) is achieved.

In a state in which the corner portion C2 of the positioned portion 131 is in contact with the contact portion 134, the worker lowers the end portion E1 in the Z direction, in other words, brings the end portion E1 closer to the bottom surface 101a of the optical box 101. Then the second imaging lens 119b climbs up the slope 137, and is temporarily placed in the optical box 101 in a state in which the surface 119b3 is in contact with the contact portion 135a (FIG. 7E). In the state of being placed temporarily, the contact portion 134 of the optical box 101 and the positioned portion 131 of the second imaging lens 119b are in contact with each other. At the other end portion of the second imaging lens 119b, the contact portion 135b and the positioned portion 132 are in contact with each other. Incidentally, in the state of being placed temporarily, the projecting portion 140 of the second imaging lens 119b is accommodated in a recessed portion 139 of the optical box 101 (see FIG. 5A and FIG. 5C).

By temporarily placing the second imaging lens 119b in a predetermined position in the optical box 101, since a posture of the second imaging lens 119b with respect to the optical box 101 is stabilized, it becomes possible to proceed subsequent assembly steps such as adhesion of the second imaging lens 119bto the optical box 101 smoothly. The worker, in the state in which the second imaging lens 119b is temporarily placed, applies the adhesive to the adhesion portion 136a and 136b. Since the positioning in the Y direction and the Z directions is done, the worker moves the second imaging lens 119b in the X direction, in more detail, in a direction in which the adhesion portion 136a and 136b are provided. As a result, at the one end portion in the longitudinal direction of the lens, the positioned portion 130a of the second imaging lens 119b is in contact with the contact portion 133a of the optical box 101, and the end portion surface 119b4 of the second imaging lens 119b and the adhesion portion 136a of the optical box 101 are adhered. In addition, at the other end portion in the longitudinal direction of the lens, the positioned portion 130b of the second imaging lens 119b is in contact with the contact portion 133b of the optical box 101, and the end portion surface 119b5 of the second imaging lens 119b and the adhesion portion 136b of the optical box 101 are adhered. Incidentally, the application of the adhesive may be done manually by the worker or by other means such as dispensing, sealing and printing.

As described above, in the Embodiment 1, upon the assembly work of the second imaging lens 119b to the optical box 101, the second imaging lens 119b is in contact with the optical box 101 in a direction of own weight of the second imaging lens 119b. Therefore, without the worker applying force, the position in the Z direction of the second imaging lens 119b with respect to the optical box 101 is determined by its own weight. Therefore, in the assembly method in which the worker grips the end portion E1 of the second imaging lens 119b and slides the second imaging lens 119bfrom the state being in contact with the optical box 101 to assemble the second imaging lens 119b to the optical box 101, the following can be done. That is, the worker can smoothly assemble the second imaging lens 119b into the predetermined position by only applying force which slides the second imaging lens 119b in the S direction to the second imaging lens 119b. As a result, it becomes possible to realize the scanning optical device 2 in which easiness in assembly of the second imaging lens 119b to the optical box 101 is improved. The same effect is achieved also in the assembly of the second imaging lens 119a.

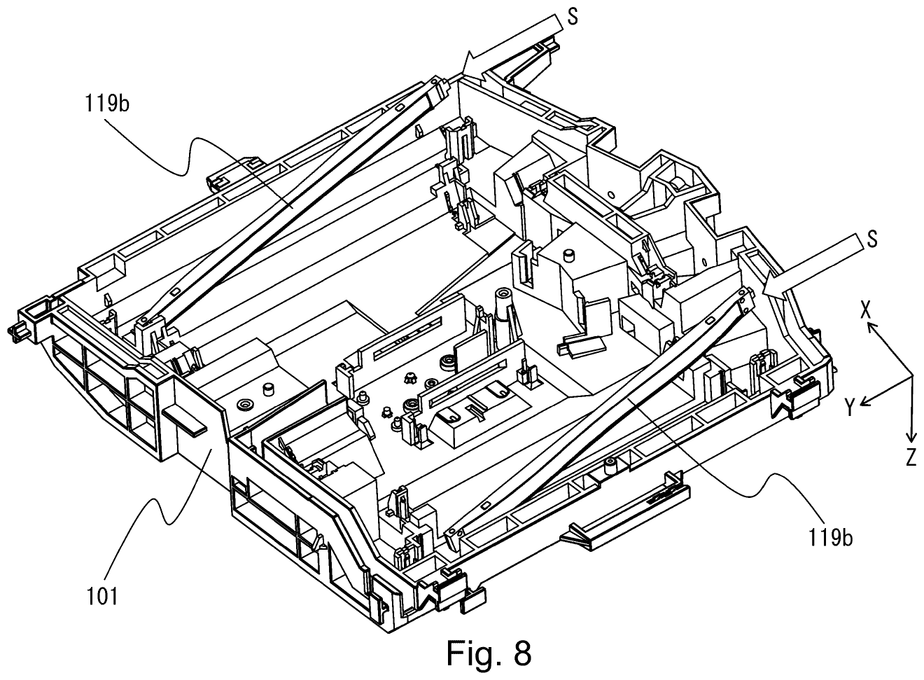

In addition, with the configuration described above, it becomes possible to assembly the second imaging lenses 119a and 119b to the optical box 101 in the state in which one ends (end portion E1) of the second imaging lens 119a, 119b are gripped. In other words, it becomes possible for one hand to grip the second imaging lens 119b for the laser luminous flux L1 and for the other hand to grip the second imaging lens 119b for the laser luminous flux L4. Therefore, as shown in FIG. 8, it becomes possible for the worker to assemble the two second imaging lenses 119b to the optical box 101 at the same time. Therefore, it becomes possible to realize the scanning optical device 2 in which efficiency in assembly of the second imaging lenses 119a and 119b is improved.

Incidentally, the inclined surface may also be provided on the other end portion side in the scanning direction. In other words, an inclined surface which becomes lower in height as it goes from the contact portion 135b to the contact portion 135a may be provided adjacent to the contact portion 135b. In addition, as shown in FIG. 13 and FIG. 14, in the case of θ2<θ1, an inclined surface, which becomes lower in height as it goes from the contact portion 133q to the contact portion 133b corresponding to the end portion of the opposite side in the longitudinal direction of the lens is provided to the contact portion 133q. Furthermore, in the case of θ2<θ1, an inclined surface which becomes lower in height as it goes from the contact portion 133b to the contact portion 133a may be provided adjacent to the contact portion 133b.

As described above, according to the Embodiment 1, it becomes possible to improve easiness in assembly of the imaging lens to the optical box.

### Embodiment 2

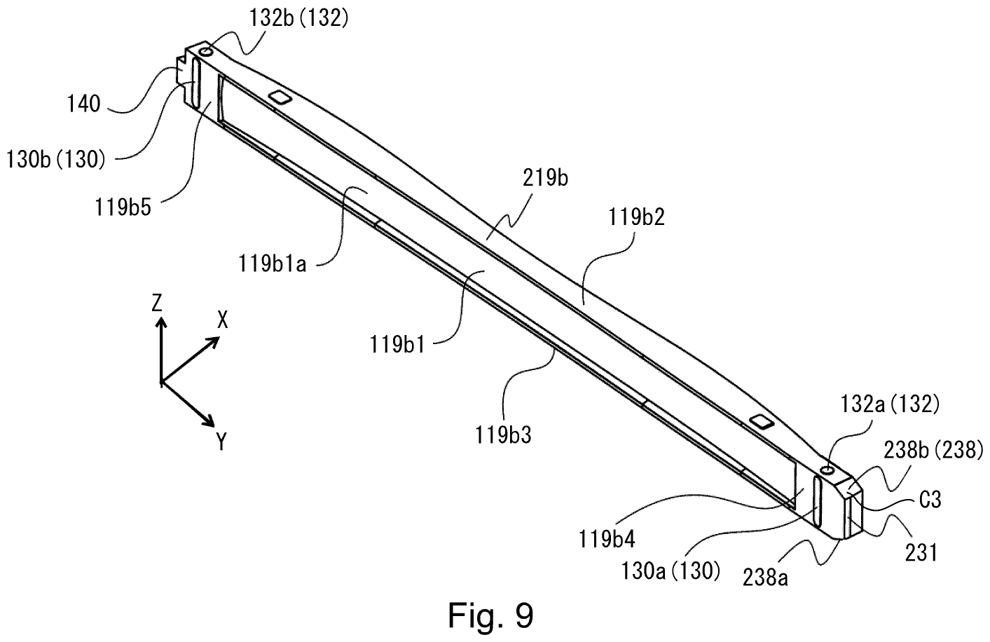

FIG. 9 is an outline view of a second imaging lens 219b in an Embodiment 2. Incidentally, the same functions and shapes as those in the Embodiment 1 are indicated with the same reference numerals, and description thereof will be omitted. In the Embodiment 2, the optical box is not provided with the inclined surface 137. Instead, an inclined surface 238 is provided on the second imaging lens 219b. In the second imaging lens 219b in the Embodiment 2, a slope 238 as an inclined surface is provided adjacent to a positioned portion 231 as a third positioned portion in the Z direction. In other words, the corner portion C1 in the Embodiment 1 becomes a slope 238b in the Embodiment 2, and the corner portion C2 becomes a slope 238a. By providing the slopes 238 at both ends of the positioned portion 231 in the Z direction, the second imaging lens 219b can be used as a common lens for the laser luminous flux L1 and the laser luminous flux L4 by reversing upside down. In addition, a corner portion formed by the positioned portion 231 and the slope 238b is configured to be a corner portion C3. The corner portion C3 can be said as a corner portion on an opposite side in the Z direction of the corner portion between the slope 238a and the positioned portion 231.

Similarly in the Embodiment 2, to the optical box 101, a contact portion 235a as a first contact portion (first positioning portion) and the contact portions 133a and 134 are provided. Therefore, even in the Embodiment 2, by reading the contact portion 135a in FIG. 6 as the contact portion 235a, an angle between the rotational axis CZ and a contact direction T1 can be defined as θ1 and an angle between the rotational axis CZ and a contacting direction T2 can be defined as θ2. Incidentally, in the Embodiment 2 as well, θ1 is configured to be 0 degree and θ2 is configured to be 90 degrees. Then, in the Embodiment 2, the slope 238a can be said as an inclined surface provided between the positioned portion 132a of θ1 with smaller angle of θ1 and θ2 and the positioned portion 231.

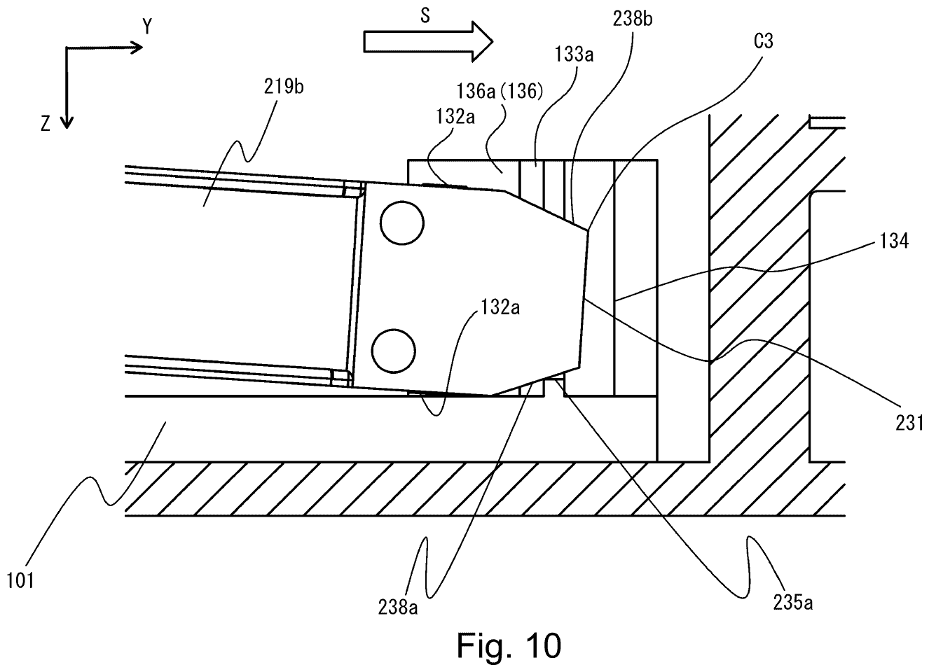

In FIG. 10, a detailed view of an assembly step of the second imaging lens 219b to the optical box 101 is illustrated. The contact portion 235a of the optical box 101 in the Embodiment 2 has a rectangular projecting shape, and the slope such as the slope 137 in the Embodiment 1 is not provided adjacent to the contact portion 235a. With such a configuration, the second imaging lens 219b is assembled to the optical box 101 using the assembly method described above. In this case, as shown in FIG. 10, since the slope 238a of the second imaging lens 219b maintains a state of being in contact with the contact portion 235a smoothly while the lens is slid in the S direction, it becomes possible for the worker to assemble the second imaging lens 219b in a predetermined position with good workability. Incidentally, by being slid in the S direction, the corner portion C3 of the second imaging lens 219b is in contact with the contact portion 134, and then the worker brings the gripping end portion E1 closer to the bottom surface 101a of the optical box 101 and temporarily places the second imaging lens 219b on the optical box 101. At this time, it is in a state in which the positioned portion 132 of the second imaging lens 219b is in contact state with the contact portion 235a of the optical box 101. Since others are the same as in the Embodiment 1, description thereof will be omitted.

As a result, it becomes possible to realize the scanning optical device 2 in which easiness in assembly of the second imaging lens 219b to the optical box 101 is improved. In addition, in the Embodiment 2, the slopes 238a and 238b are planes, however, it is not limited to this shape. For example, as long as the slopes 238a and 238b have surfaces without irregularities such as an arc shape, the same effect as the configuration described above can be obtained.

As described above, according to the Embodiment 2, it becomes possible to improve easiness in assembly of the imaging lens to the optical box.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2024-062050 filed on Apr. 8, 2024 and 2025-027810 filed on Feb. 25, 2025, which are hereby incorporated by reference herein in their entirety.

What is claimed is:

1. A scanning optical device comprising:
a light source;
a rotatable polygon mirror configured to deflect and scan a luminous flux emitted from the light source;
an imaging lens long in a scanning direction of the rotatable polygon mirror and configured to image the luminous flux deflected and scanned by the rotatable polygon mirror onto a scanned surface; and
an optical box in which the rotatable polygon mirror and the imaging lens are provided,
wherein the optical box includes a positioning portion configured to position one end portion of the imaging lens in the scanning direction and a positioning portion configured to position the other end portion of the imaging lens in the scanning direction, and
wherein in a position adjacent to the one positioning portion of the two positioning portions in the scanning direction and on a side of the other positioning portion, an inclined surface, extending in a direction from the one positioning portion toward the other positioning portion and inclined so as to lower in height as it goes to the other positioning portion from the one positioning portion, is provided.

2. The scanning optical device according to claim 1, wherein when the positioning portion is a first positioning portion and a direction wherein the imaging lens is in contact with the first positioning portion is a first contact direction,
wherein the optical box incudes a second positioning portion configured to position the imaging lens in a second contact direction crossing both the first contact direction and the scanning direction, and
wherein when an angle formed between a rotational axis of the rotatable polygon mirror and the first contact direction is a first angle and an angle formed between the rotational axis and the second contact direction is a second angle, the inclined surface is provided adjacent to the positioning portion with a smaller angle of the first angle and the second angle.

3. The scanning optical device according to claim 2, wherein when the first angle is 0 degree and the second angle is 90 degrees, the optical box includes a third positioning portion configured to position the imaging lens in the scanning direction, and
wherein the inclined surface is disposed in a position adjacent to the first positioning portion in the scanning direction and on a side far from the third positioning portion.

4. A scanning optical device comprising:
a light source;
a rotatable polygon mirror configured to deflect and scan a luminous flux emitted from the light source;
an imaging lens long in a scanning direction of the rotatable polygon mirror and configured to image the luminous flux deflected and scanned by the rotatable polygon mirror onto a scanned surface; and
an optical box in which the rotatable polygon mirror and the imaging lens are provided,
wherein the imaging lens includes
a first positioned portion provided in a direction perpendicular to the scanning direction and in contact with the optical box in a first contact direction,
a second positioned portion provided in a direction crossing the first positioned portion in an imaginary plane perpendicular to the scanning direction and in contact with the optical box in a second contact direction crossing the first contact direction,
a third positioned portion in contact with the optical box in the scanning direction, and
an inclined surface, the inclined surface being provided, when an angle formed between a rotational axis of the rotatable polygon mirror and the first contact direction is a first angle and an angle formed between the rotational axis and the second contact direction is a second angle, between a positioned portion with a smaller angle of the first angle and the second angle and the third positioned portion.

5. The scanning optical device according to claim 4, wherein the optical box includes a first positioning portion protruding from a periphery and configured to contact the first positioned portion and a second positioning portion configured to contact the second positioned portion.

6. An image forming apparatus comprising:
an image bearing member configured to bear an electrostatic latent image;
a scanning optical device according to claim 1 and configured to form the electrostatic latent image;
a developing means configured to develop the electrostatic latent image and form a toner image; and
a transfer means configured to transfer the toner image to a recording material.

7. An assembly method for an imaging lens of a scanning optical device, wherein the scanning optical device includes a light source, a rotatable polygon mirror configured to deflect and scan a luminous flux emitted from the light source, an imaging lens long in a scanning direction of the rotatable polygon mirror and configured to image the luminous flux deflected and scanned by the rotatable polygon mirror onto a scanned surface, and an optical box including a bottom surface on which the rotatable polygon mirror and the imaging lens are provided,
wherein the optical box in one end portion thereof in the scanning direction, includes a first positioning portion protruding from a periphery and configured to position the imaging lens in a first contact direction perpendicular to the scanning direction, a second positioning portion configured to position the imaging lens in a second contact direction perpendicular to the scanning direction and crossing the first contact direction, a third positioning portion configured to position the imaging lens in the scanning direction, and an inclined surface extending so as to lower in height as it goes to the other end portion in the scanning direction from the first positioning portion, and
wherein the imaging lens includes a first positioned portion in contact with the first positioning portion, a second positioned portion in contact with the second positioning portion, a third positioned portion in contact with the third positioning portion, a first corner portion between the first positioned portion and the third positioned portion, and a second corner portion between the first positioned portion and the third positioned portion and opposite to the first corner portion, and the assembling method comprising:
a step for moving up the first corner portion along the inclined surface by bringing the first corner portion into contact with the bottom surface and sliding the imaging lens toward the first positioning portion;
a step for contacting the second corner portion to the third positioning portion and for bringing the third positioned portion into contact with the third positioning portion while moving the other end portion of the imaging lens in the scanning direction toward the bottom surface;
a step for temporarily placing the imaging lens on the bottom surface by bringing the first positioned portion into contact with the first positioning portion; and
a step for bringing the second positioned portion into contact with the second positioning portion.

8. An assembly method for an imaging lens of a scanning optical device, wherein the scanning optical device includes a light source, a rotatable polygon mirror configured to deflect and scan a luminous flux emitted from the light source, an imaging lens long in a scanning direction of the rotatable polygon mirror and configured to image the luminous flux deflected and scanned by the rotatable polygon mirror onto a scanned surface, and an optical box including a bottom surface on which the rotatable polygon mirror and the imaging lens are provided,
wherein the imaging lens includes a first positioned portion provided in a direction perpendicular to the scanning direction and in contact with the optical box in a first contact direction, a second positioned portion provided in a direction crossing the first positioned portion in an imaginary plane perpendicular to the scanning direction and in contact with the optical box in a second contact direction crossing the first contact direction, a third positioned portion in contact with the optical box in the scanning direction, and an inclined surface, the inclined surface being provided, when an angle formed between a rotational axis of the rotatable polygon mirror and the first contact direction is a first angle and an angle formed between the rotational axis and the second contact direction is a second angle, between a positioned portion with a smaller angle of the first angle and the second angle and the third positioned portion. and the assembling method comprising:
a step for moving the first positioning portion and the inclined surface in a state in contact with each other by bringing on an end portion of the imaging lens into contact with the bottom surface and sliding toward the first positioning portion;
a step for contacting a corner portion opposite to a corner portion between the inclined surface in contact with the bottom surface and the third positioned portion to the third positioning portion and for bringing the third positioned portion into contact with the third positioning portion while moving the other end portion of the imaging lens in the scanning direction toward the bottom surface;
a step for temporarily placing the imaging lens on the bottom surface by bringing the first positioned portion into contact with the first positioning portion; and
a step for bringing the second positioned portion into contact with the second positioning portion.
